(19) United States
(12) Patent Application Publication
(10) Pub. No.: US 2026/0229698 A1
(43) Pub. Date: Aug. 6, 2026

(54) SECONDARY BATTERY

(71) Applicants: TOYOTA JIDOSHA KABUSHIKI KAISHA, Toyota-shi (JP); PRIME PLANET ENERGY & SOLUTIONS, INC., Tokyo (JP)

(72) Inventors: Norihiro OSE, Nagoya-shi (JP); Masato ONO, Nagoya-shi (JP); Yasuhiro SAKASHITA, Nisshin-shi (JP); Koichi YANASE, Nagoya-shi (JP); Takeru HARA, Toyota-shi (JP); Yuka YOKOI, Nagoya-shi (JP); Kohji UMEMURA, Okazaki-shi (JP); Toshiki IMABORI, Kasai-shi (JP); Yoshinori HIRANO, Nagoya-shi (JP); Satoshi FUJIMURA, Toki-shi (JP)

(73) Assignees: TOYOTA JIDOSHA KABUSHIKI KAISHA, Toyota-shi (JP); PRIME PLANET ENERGY & SOLUTIONS, INC., Tokyo (JP)

(21) Appl. No.: 19/434,141

(22) Filed: Dec. 29, 2025

(30) Foreign Application Priority Data
Feb. 6, 2025 (JP) 2025-018331

(51) Int. Cl. H01M 50/392; H01M 50/342; H01M 50/586

(52) U.S. Cl. CPC H01M 50/392; H01M 50/342; H01M 50/586; H01M 2220/20

(57) ABSTRACT

A secondary battery includes an electrode assembly, an electrolyte solution, a case, and an exhaust valve. The case houses the electrode assembly and the electrolyte solution. The case includes a bottom plate. The bottom plate is located below the electrode assembly. The bottom plate includes a first portion and a second portion. The exhaust valve is provided to the first portion. The second portion is spaced away from the exhaust valve. The first portion includes a first inner surface oriented to a housing space of the case. The second portion includes a second inner surface oriented to the housing space of the case. The second inner surface is located downward of the first inner surface.

### CROSS-REFERENCE TO RELATED APPLICATION

This application claims priority to Japanese Patent Application No. 2025-018331 filed on Feb. 6, 2025. The disclosure of the above-identified application, including the specification, drawings, and claims, is incorporated by reference herein in its entirety.

### BACKGROUND

### 1. Technical Field

The present disclosure relates to a secondary battery.

### 2. Description of Related Art

Japanese Unexamined Patent Application Publication (Translation of PCT Application) No. 2022-543185 (JP 2022-543185 A) discloses a battery. The battery includes a plurality of battery cells and a bus member. The bus member serves to electrically connect the battery cells. The battery cell includes a relief mechanism and a housing. The relief mechanism is operable to release an internal pressure when the internal pressure or temperature of the battery cell reaches a threshold value. The relief mechanism is also called an explosion-proof valve, an air valve, a relief valve, a safety valve, etc. For example, when the battery is applied to a battery electric vehicle, a high-voltage side on which the bus member is installed is located to adjoin a driver's cab due to wiring and other factors. When the relief mechanism is disposed on a different side, substances from the battery cell can be discharged away from the bus member during the operation of the relief mechanism. The housing is formed by a plurality of walls. The relief mechanism is disposed on at least one of the walls.

### SUMMARY

When an exhaust valve is disposed on a bottom plate of a battery cell case and the exhaust valve is opened, a large amount of excess electrolyte solution that has accumulated inside the case is also discharged to the outside.

The present disclosure has been made in view of the above issue, and provides a secondary battery that can suppress discharge of excess electrolyte solution to the outside when an exhaust valve is opened.

A secondary battery according to an aspect of the present disclosure includes an electrode assembly, an electrolyte solution, a case, and an exhaust valve. The case houses the electrode assembly and the electrolyte solution. The case includes a bottom plate. The bottom plate is located below the electrode assembly. The bottom plate includes a first portion and a second portion. The exhaust valve is provided to the first portion. The second portion is spaced away from the exhaust valve. The first portion includes a first inner surface oriented to a housing space of the case. The second portion includes a second inner surface oriented to the housing space of the case. The second inner surface is located downward of the first inner surface.

It is possible to suppress discharge of excess electrolyte solution to the outside when the exhaust valve is opened.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view schematically showing an example of a vehicle equipped with a power storage device including a secondary battery according to an embodiment;

FIG. 2 is a sectional view showing the secondary battery according to the embodiment;

FIG. 3 is a sectional view partially showing the secondary battery according to the embodiment; and

FIG. 4 is a partial bottom view of the secondary battery according to the embodiment as seen from below.

### DETAILED DESCRIPTION OF EMBODIMENTS

Hereinafter, a secondary battery according to an embodiment of the present disclosure will be described with reference to the drawings. The same reference signs denote the same or equivalent portions in the drawings, and the description of such portions will not be repeated.

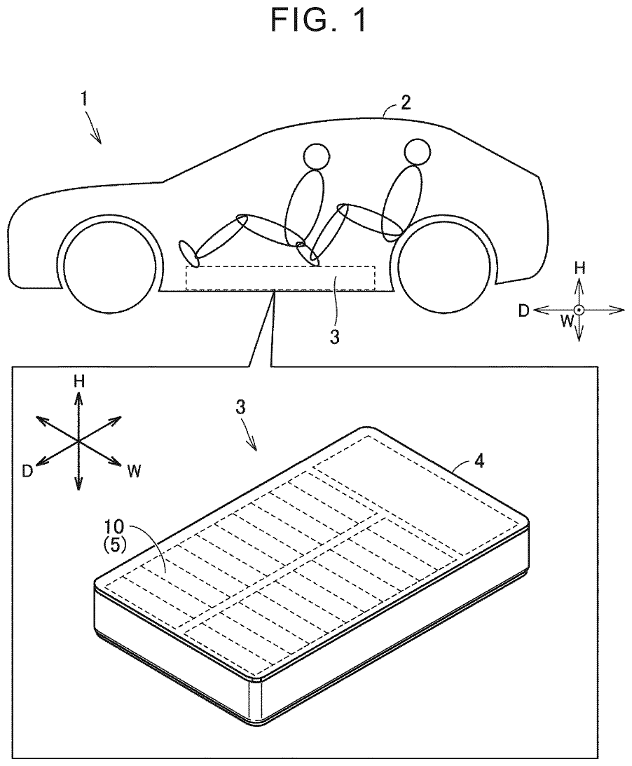

FIG. 1 is a side view schematically showing an example of a vehicle equipped with a power storage device including the secondary battery according to the embodiment. The symbol “H” shown in FIG. 1 represents an up-down direction that is an up-down direction of a vehicle 1. The symbol “W” represents a width direction of the vehicle 1. The symbol “D” represents a front-rear direction of the vehicle 1.

As shown in FIG. 1, the vehicle 1 includes a vehicle body 2 and a power storage device 3. Examples of the vehicle 1 include a plug-in hybrid electric vehicle (PHEV), a battery electric vehicle (BEV), and a fuel cell electric vehicle (FCEV). The power storage device 3 is mounted in a lower portion of the vehicle body 2. The power storage device 3 includes a housing case 4 and a power storage stack 5. The power storage stack 5 is housed in a housing space of the housing case 4. The power storage stack 5 can be formed from a plurality of secondary batteries 10 (secondary battery cells) according to the embodiment of the present disclosure.

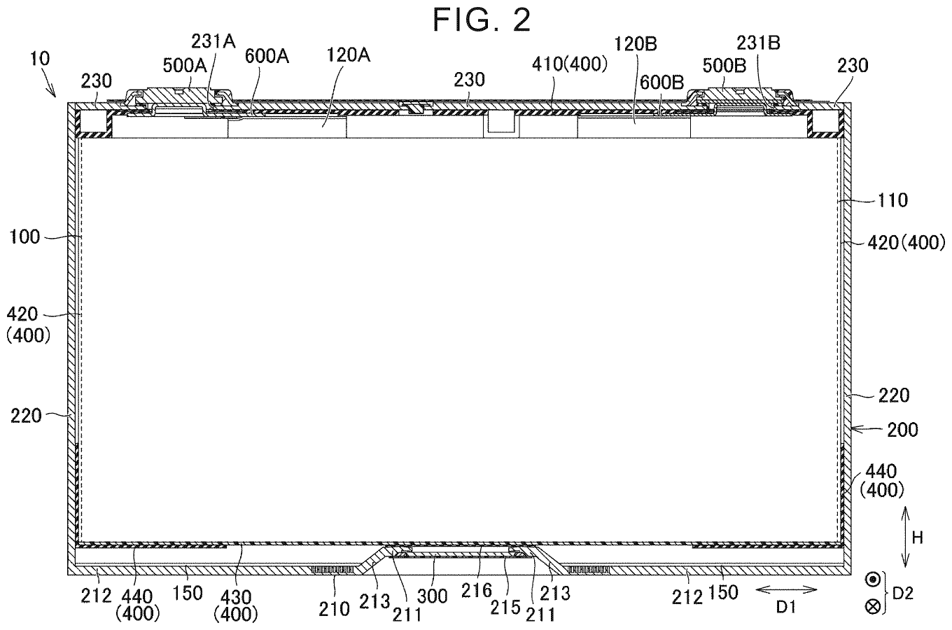

FIG. 2 is a sectional view showing the secondary battery according to the embodiment. In FIG. 2 and subsequent drawings, the symbol “D1” represents a first direction of the secondary battery. The first direction is a direction orthogonal to the up-down direction. The symbol “D2” represents a second direction of the secondary battery. The second direction is a direction orthogonal to both the first direction and the up-down direction. In the present embodiment, the first direction is the width direction of the vehicle 1, but may be the front-rear direction of the vehicle 1.

The secondary battery 10 shown in FIG. 2 is a so-called prismatic battery. The secondary battery 10 is chargeable and dischargeable, and may be, for example, a lithium ion battery or a nickel metal hydride battery.

The secondary battery 10 according to the embodiment of the present disclosure includes an electrode assembly 100, an electrolyte solution 150, a case 200, an exhaust valve 300, an insulating member 400, a first external terminal 500A, a second external terminal 500B, a first connecting member 600A, and a second connecting member 600B.

The electrode assembly 100 includes an electrode assembly body 110, a first tab 120A, and a second tab 120B.

The electrode assembly body 110 may be, for example, a wound electrode assembly formed by winding a cathode sheet, a separator, and an anode sheet laminated on top of each other around a virtual central axis extending in the up-down direction. The cathode sheet includes a cathode metal foil and a cathode composite layer provided on the cathode metal foil. The anode sheet includes an anode metal foil and an anode composite layer formed on the metal foil. The electrode assembly body 110 may be a laminated electrode assembly formed by laminating a plurality of cathode sheets, a plurality of separators, and a plurality of anode sheets in the second direction.

The first tab 120A and the second tab 120B extend upward from the electrode assembly body 110. The first tab 120A may be, for example, a cathode tab. The cathode tab may be formed from a portion of the cathode metal foil on which the cathode composite layer is not provided, or may be connected to the cathode metal foil. The second tab 120B extends upward from the electrode assembly body 110. The second tab 120B may be, for example, an anode tab. The anode tab may be formed from a portion of the anode metal foil on which the anode composite layer is not provided, or may be connected to the anode composite layer.

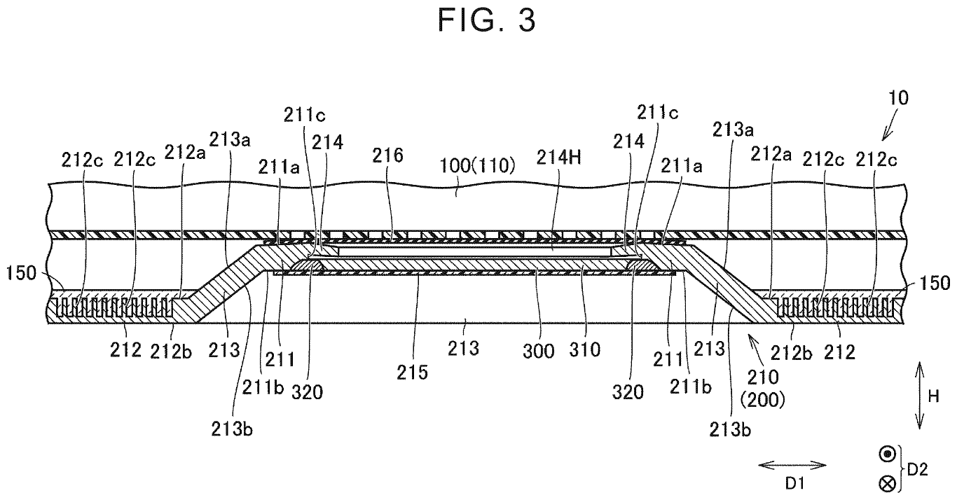

The electrolyte solution 150 may be a non-aqueous electrolyte solution. The electrolyte solution 150 may contain, for example, a lithium salt and an organic solvent. The electrolyte solution 150 is impregnated into the electrode assembly body 110 of the electrode assembly 100. In the secondary battery 10, the excess electrolyte solution 150 may be located downward of the electrode assembly body 110 of the electrode assembly 100. The excess electrolyte solution 150 is shown in FIG. 2 and in FIG. 3 described later.

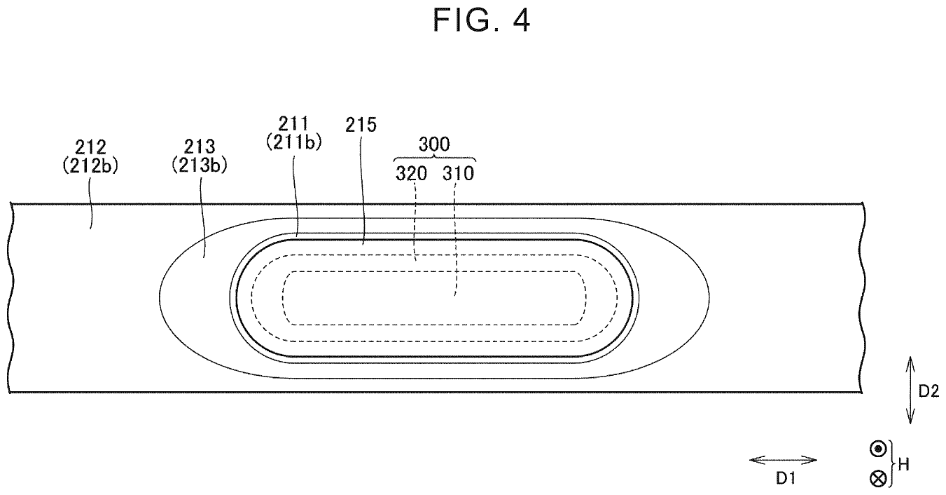

FIG. 3 is a sectional view partially showing the secondary battery according to the embodiment. FIG. 4 is a partial bottom view of the secondary battery according to the embodiment as seen from below.

As shown in FIGS. 2 to 4, the case 200 houses the electrode assembly 100 and the electrolyte solution 150.

The case 200 includes a bottom plate 210, a peripheral wall 220, and a lid 230. The bottom plate 210 is located below the electrode assembly 100. The bottom plate 210 includes a first portion 211, a second portion 212, a third portion 213, a fourth portion 214, an outer protective film 215, and an inner protective film 216. The first portion 211, the second portion 212, the third portion 213, and the fourth portion 214 are electrically conductive and made of a metal such as aluminum.

The first portion 211 is provided with the exhaust valve 300. The first portion 211 includes a first inner surface 211a, a first outer surface 211b, and a first through hole 211c.

The first inner surface 211a is oriented to the housing space of the case 200. The first outer surface 211b is oriented to the outside of the case 200. The first through hole 211c passes through the first portion 211 in the up-down direction. The exhaust valve 300 closes the first through hole 211c.

The second portion 212 is spaced away from the exhaust valve 300. The second portion 212 is located to surround the first portion 211 when viewed in the up-down direction (see FIG. 4).

The second portion 212 includes a second inner surface 212a, a second outer surface 212b, and a plurality of grooves 212c. The second inner surface 212a is oriented to the housing space of the case 200. The second inner surface 212a is located downward of the first inner surface 211a. The second inner surface 212a extends in a horizontal direction. The second outer surface 212b is oriented to the outside of the case 200. The second outer surface 212b is located downward of the first outer surface 211b. The second outer surface 212b extends in the horizontal direction. The grooves 212c extend downward from the second inner surface 212a. The width of each of the grooves 212c may be any dimension that allows the excess electrolyte solution 150 to enter by capillary action. The width of each of the grooves 212c may be, for example, more than 1 nm and less than 100 nm. The grooves 212c may be omitted.

The third portion 213 extends in an annular shape (see FIG. 4). The third portion 213 includes a third inner surface 213a and a third outer surface 213b. The third inner surface 213a is oriented to the housing space of the case 200. The third inner surface 213a connects the first inner surface 211a and the second inner surface 212a. The third inner surface 213a is inclined downward from the first inner surface 211a toward the second inner surface 212a. The third outer surface 213b connects the first outer surface 211b and the second outer surface 212b. The third outer surface 213b is inclined downward from the first outer surface 211b toward the second outer surface 212b.

The fourth portion 214 extends from the first portion 211. The fourth portion 214 is located upward of the exhaust valve 300. The fourth portion 214 has a second through hole 214H that passes through the fourth portion 214 in the up-down direction. The second through hole 214H is located upward of the exhaust valve 300.

The outer protective film 215 covers the exhaust valve 300 from the outside. The outer protective film 215 is provided on the first outer surface 211b. The outer protective film 215 is made of an electrically insulating resin.

The inner protective film 216 covers the exhaust valve 300 from the inside. The inner protective film 216 is provided on the first inner surface 211a. The inner protective film 216 is made of an electrically insulating resin.

The peripheral wall 220 stands upward from the peripheral edge of the second portion 212 of the bottom plate 210. An opening is formed at the upper end of the peripheral wall 220. The peripheral wall 220 has a substantially rectangular outer shape when viewed in the opening direction of the opening. The opening and the bottom plate 210 are arranged in the up-down direction. The peripheral wall 220 is made of a metal such as aluminum.

The lid 230 is joined to the peripheral wall 220 by welding etc. to close the opening of the peripheral wall 220. The lid 230 has a first connecting hole 231A and a second connecting hole 231B.

The exhaust valve 300 is made of a metal such as aluminum. The thickness of the exhaust valve 300 is smaller than the thickness of any of the first portion 211, the second portion 212, and the third portion 213. The thickness of the second portion 212 in this case may be the thickness of a portion of the second portion 212 in which the grooves 212c are not provided.

The exhaust valve 300 includes a valve body 310 and a weld 320. When viewed in the up-down direction, the weld 320 is located radially outward of the valve body 310 and extends in an annular shape. The weld 320 is connected to the first portion 211. The weld 320 may be formed by fusing part of the material of the valve body 310 with the first portion 211 by laser welding etc.

The insulating member 400 is electrically insulating. The insulating member 400 is disposed between the electrode assembly 100 and the case 200. The insulating member 400 electrically insulates the electrode assembly 100 and the case 200 from each other. The insulating member 400 includes an insulating bracket 410, a peripheral insulating portion 420, a bottom insulating portion 430, and an insulating tape 440.

The insulating bracket 410 is disposed between the electrode assembly 100 and the lid 230. The insulating bracket 410 has a relatively high rigidity and is in contact with both the electrode assembly 100 and the lid 230. Thus, the electrode assembly 100 is fixed to the case 200 in the up-down direction.

The peripheral insulating portion 420 is disposed between the electrode assembly 100 and the peripheral wall 220. The peripheral insulating portion 420 is a film-shaped member.

The bottom insulating portion 430 is disposed between the electrode assembly 100 and the bottom plate 210. The bottom insulating portion 430 is a film-shaped member.

The insulating tape 440 is bonded to both the peripheral insulating portion 420 and the bottom insulating portion 430. The insulating tape 440 fixes the peripheral insulating portion 420 and the bottom insulating portion 430 to each other.

The first external terminal 500A and the second external terminal 500B are provided in the secondary battery 10 so as to be exposed to the outside. The first connecting member 600A and the second connecting member 600B are electrically conductive. At least part of the first connecting member 600A and at least part of the second connecting member 600B are disposed inside the case 200.

The first external terminal 500A or the first connecting member 600A is inserted through the first connecting hole 231A. The first external terminal 500A is electrically connected to the first connecting member 600A. Specifically, the first external terminal 500A and the first connecting member 600A are joined to each other. The first connecting member 600A is joined to the first tab 120A. Thus, the first external terminal 500A is electrically connected to the first tab 120A.

The second external terminal 500B or the second connecting member 600B is inserted through the second connecting hole 231B. The second external terminal 500B is electrically connected to the second connecting member 600B. Specifically, the second external terminal 500B and the second connecting member 600B are joined to each other. The second connecting member 600B is joined to the second tab 120B. Thus, the second external terminal 500B is electrically connected to the second tab 120B.

In the present embodiment, the first external terminal 500A is a cathode terminal, and the second external terminal 500B is an anode terminal. The first external terminal 500A and the second external terminal 500B are arranged in the first direction.

As described above, the secondary battery 10 according to the embodiment of the present disclosure includes the electrode assembly 100, the electrolyte solution 150, the case 200, and the exhaust valve 300. The case 200 houses the electrode assembly 100 and the electrolyte solution 150. The case 200 includes the bottom plate 210. The bottom plate 210 is located below the electrode assembly 100. The bottom plate 210 includes the first portion 211 and the second portion 212. The exhaust valve 300 is provided to the first portion 211. The second portion 212 is spaced away from the exhaust valve 300. The first portion 211 includes the first inner surface 211a oriented to the housing space of the case 200. The second portion 212 includes the second inner surface 212a oriented to the housing space of the case 200. The second inner surface 212a is located downward of the first inner surface 211a.

With the above configuration, the excess electrolyte solution 150 is likely to accumulate on the second inner surface 212a located downward of the first inner surface 211a. Thus, the liquid surface of the excess electrolyte solution 150 can easily be located downward of the first inner surface 211a. Therefore, it is possible to suppress discharge of the excess electrolyte solution 150 to the outside when the exhaust valve 300 provided to the first portion 211 is opened.

In the present embodiment, the second inner surface 212a extends in the horizontal direction. With this configuration, the excess electrolyte solution 150 is more likely to remain on the second inner surface 212a. Furthermore, the excess electrolyte solution 150 on the second inner surface 212a is less likely to flow toward the first inner surface 211a. Therefore, it is possible to further suppress discharge of the excess electrolyte solution 150 to the outside when the exhaust valve 300 provided to the first portion 211 is opened.

In the present embodiment, the bottom plate 210 further includes the third portion 213. The third portion 213 includes the third inner surface 213a oriented to the housing space of the case 200. The third inner surface 213a connects the first inner surface 211a and the second inner surface 212a. The third inner surface 213a is inclined downward from the first inner surface 211a toward the second inner surface 212a.

With the above configuration, the excess electrolyte solution 150 on the first inner surface 211a is more likely to flow onto the second inner surface 212a. Therefore, it is possible to further suppress discharge of the excess electrolyte solution 150 to the outside when the exhaust valve 300 provided to the first portion 211 is opened.

In the present embodiment, the first portion 211 further includes the first outer surface 211b oriented to the outside of the case 200. The second portion 212 further includes the second outer surface 212b oriented to the outside of the case 200. The second outer surface 212b is located downward of the first outer surface 211b.

With the above configuration, when the case 200 is installed (e.g., inside the housing case 4), it is possible to suppress hindrance of the exhaust valve 300 provided to the first portion 211 to the installation of the case 200.

In the present embodiment, the second portion 212 further includes the grooves 212c. The grooves 212c extend downward from the second inner surface 212a.

With the above configuration, the excess electrolyte solution 150 housed in the case 200 enters the grooves 212c by capillary action. Therefore, it is possible to further suppress discharge of the excess electrolyte solution 150 to the outside when the exhaust valve 300 provided to the first portion 211 is opened.

In the above description of the embodiment, configurations that can be combined may be combined with each other.

The embodiment disclosed herein should be considered to be exemplary in all respects and not restrictive. The scope of the present disclosure is defined by the claims rather than by the above description, and is intended to include all modifications within the meaning and scope equivalent to those of the claims.

What is claimed is:

1. A secondary battery comprising:
an electrode assembly;
an electrolyte solution;
a case; and
an exhaust valve, wherein
the case houses the electrode assembly and the electrolyte solution,
the case includes a bottom plate,
the bottom plate is located below the electrode assembly,
the bottom plate includes a first portion and a second portion,
the exhaust valve is provided to the first portion,
the second portion is spaced away from the exhaust valve,
the first portion includes a first inner surface oriented to a housing space of the case,
the second portion includes a second inner surface oriented to the housing space of the case, and
the second inner surface is located downward of the first inner surface.

2. The secondary battery according to claim 1, wherein the second inner surface extends in a horizontal direction.

3. The secondary battery according to claim 2, wherein:
the bottom plate further includes a third portion;
the third portion includes a third inner surface oriented to the housing space of the case;
the third inner surface connects the first inner surface and the second inner surface; and
the third inner surface is inclined downward from the first inner surface toward the second inner surface.

4. The secondary battery according to claim 3, wherein:
the first portion further includes a first outer surface oriented to an outside of the case;
the second portion further includes a second outer surface oriented to the outside of the case; and
the second outer surface is located downward of the first outer surface.

5. The secondary battery according to claim 1, wherein:
the second portion further includes a plurality of grooves; and
the grooves extend downward from the second inner surface.
